(19) United States
(12) Patent Application Publication
(10) Pub. No.: US 2025/0373166 A1
(43) Pub. Date: Dec. 4, 2025

(54) MULTI-OUTPUT CONVERTER AND CONTROL CIRCUIT THEREOF

(71) Applicant: Chengdu Monolithic Power Systems Co., Ltd., Chengdu (CN)

(72) Inventors: Qiao’an Zuo, Hangzhou (CN); En Li, Hangzhou (CN)

(21) Appl. No.: 19/223,007

(22) Filed: May 29, 2025

(30) Foreign Application Priority Data
Jun. 3, 2024 (CN) 202410711645.X

(51) Int. Cl. H02M 3/335; H02M 1/36

(52) U.S. Cl. CPC H02M 3/33561; H02M 1/36

(57) ABSTRACT

A control circuit for a multi-output converter. The control circuit includes a first feedback pin and a second feedback pin. The first feedback pin is coupled to a first output terminal of the multi-output converter and receives a first feedback signal indicative of a first output signal. The second feedback pin is coupled to a second output terminal of the multi-output converter and receives a second feedback signal indicative of a second output signal. The control circuit controls a first secondary switch coupled to the first output terminal and a second secondary switch coupled to the second output terminal based on the first feedback signal and the second feedback signal. Where during a first switching cycle of multiple switching cycles, the control circuit is configured to turn on the first secondary switch and the second secondary switch in a time-multiplexed manner.

### CROSS-REFERENCE TO RELATED APPLICATIONS

This application claims the benefit of CN application No. 202410711645.X, filed on Jun. 3, 2024, and incorporated herein by reference.

### TECHNICAL FIELD OF THE INVENTION

The present invention generally relates to electronic circuits, and more particularly but not exclusively, to multi-output converters and associated control circuits and control methods.

### BACKGROUND OF THE INVENTION

Compared with 4G communication field, 5G has a higher frequency band, larger bandwidth and greater path loss, it requires more on the materials and processes for the FR (radio frequency) devices. The GaN materials are suitable for higher frequency applications and provide the possibility for the further development of 5G and even 6G industry. In small stations, some blocks such as communication blocks usually require a low supply voltage (such as 5V), while GaN PA (power amplifier) usually requires a higher supply voltage (such as 8˜20V), which requires power supplies to provide two regulated supply voltage. Conventionally, a two-stage structure is used to convert an input voltage into different output voltages to power different loads. For example, a first stage converter converts the input voltage into a low voltage to power the communication blocks. A second stage converter converts the low voltage provided by the first stage converter to a higher voltage to power the GaN PA. However, the two-stage structure has disadvantages of large space, high cost and poor efficiency, and cannot achieve satisfactory performance.

### SUMMARY OF THE INVENTION

An embodiment of the present invention discloses a control circuit for a multi-output converter. The control circuit includes a first feedback pin and a second feedback pin. The first feedback pin is configured to be coupled to a first output terminal of the multi-output converter and configured to receive a first feedback signal indicative of a first output signal. The second feedback pin is configured to be coupled to a second output terminal of the multi-output converter and configured to receive a second feedback signal indicative of a second output signal. The control circuit is configured to control a first secondary switch coupled to the first output terminal and a second secondary switch coupled to the second output terminal based on the first feedback signal and the second feedback signal. Where during a first switching cycle of multiple switching cycles, the control circuit is configured to turn on the first secondary switch and the second secondary switch in a time-multiplexed manner.

An embodiment of the present invention discloses a multi-output converter including a transformer, a primary switch, a first secondary switch, a second secondary switch and a control circuit. The transformer has a primary winding, a first secondary winding and a second secondary winding. The primary switch is coupled to the primary winding. The first secondary switch is coupled between the first secondary winding and a first output terminal. The second secondary switch is coupled between the second secondary winding and a second output terminal. The control circuit is configured to receive a first feedback signal indicative of a first output signal provided through the first output terminal and a second feedback signal indicative of a second output signal provided through the second output terminal and configured to control the primary switch, the first secondary switch and the second secondary switch based on the first feedback signal and the second feedback signal. Where during a first time period of a first switching cycle of multiple switching cycles, the control circuit is configured to turn on both the first secondary switch and the primary switch.

An embodiment of the present invention discloses a control method for a multi-output converter. The control method includes the following steps. 1) Receiving a first feedback signal indicative of a first output signal provided through a first output terminal. 2) Receiving a second feedback signal indicative of a second output signal provided through a second output terminal. 3) Controlling a primary switch, a first secondary switch and a second secondary switch based on the first feedback signal and the second feedback signal. And 4) during a first time period of a first switching cycle of multiple switching cycles, turning on both the primary switch and the first secondary switch.

### BRIEF DESCRIPTION OF DRAWINGS

The present invention can be further understood with reference to the following detailed description and the appended drawings, wherein like elements are provided with like reference numerals.

FIG. 1 illustrates a block diagram of a multi-output converter 100 in accordance with an embodiment of the present invention.

FIG. 2(a) and FIG. 2(b) illustrate working states and working waveforms of the multi-output converter 100 operating in a CCM (continuous conduction mode) in accordance with an embodiment of the present invention.

FIG. 3(a) and FIG. 3(b) illustrate working states and working waveforms of the multi-output converter 100 operating in a DCM (discontinuous conduction mode) in accordance with another embodiment of the present invention.

FIG. 4 illustrates a block diagram of a multi-output converter 100A in accordance with another embodiment of the present invention.

FIG. 5(a) and FIG. 5(b) illustrate a block diagram and working waveforms of a multi-output converter 100B in accordance with an embodiment of the present invention.

FIG. 6 illustrates a circuit schematic of a multi-output converter 100C in accordance with an embodiment of the present invention.

FIG. 7 illustrates a circuit schematic of a multi-output converter 100D in accordance with another embodiment of the present invention.

FIG. 8 illustrates a working flowchart of a control method 800 used in a multi-output converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

In the following embodiments, for simplicity, flyback converter is used as an example for illustration. However, the present invention can be applied to other suitable switching converters.

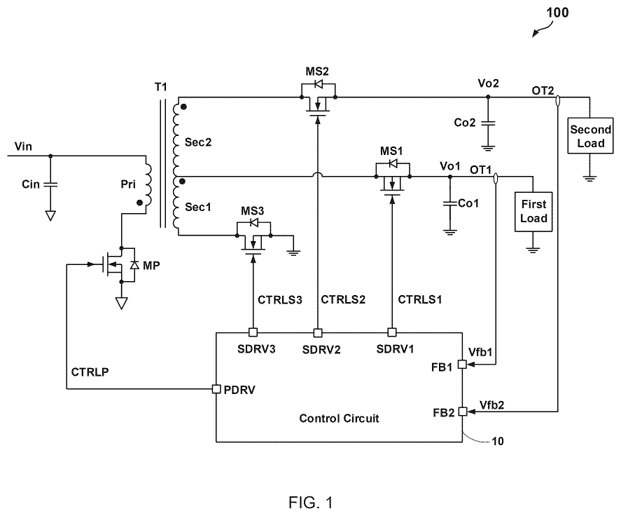

FIG. 1 illustrates a block diagram of a multi-output converter 100 in accordance with an embodiment of the present invention. In the example shown in FIG. 1, the multi-output converter 100 includes an input capacitor Cin, a transformer T1, a primary switch MP, a first secondary switch MS1, a second secondary switch MS2, a third secondary switch MS3, a first output capacitor Co1, a second output capacitor Co2 and a control circuit 10. The transformer T1 has a primary winding Pri, a first secondary winding Sec1 and a second secondary winding Sec2, where the primary winding Pri, the first secondary winding Sec1 and the second secondary winding Sec2 all have a first terminal and a second terminal. The first terminal of the primary winding Pri is configured to receive an input voltage Vin. The primary switch MP is coupled between the second terminal of the primary winding Pri and a primary reference ground.

As shown in FIG. 1, the first secondary switch MS1 is coupled between the first output capacitor Co1 and the first terminal of the first secondary winding Sec1. A first load is coupled to a first output terminal OT1 of the multi-output converter 100. The second secondary switch MS2 is coupled between the second output capacitor Co2 and the first terminal of the second secondary winding Sec2. A second load is coupled to a second output terminal OT2 of the multi-output converter 100. The second terminal of the second secondary winding Sec2 is coupled to the first terminal of the first secondary winding Sec1. The third secondary switch MS3 is coupled between the second terminal of the first secondary winding Sec1 and a secondary reference ground. In one embodiment, the third secondary switch MS3 can be replaced by a diode.

In the example shown in FIG. 1, the primary switch MP, the first secondary switch MS1, the second secondary switch MS2 and the third secondary switch MS3 are all shown as external to the control circuit 10. Those skilled in the art can understand that, in other embodiments, the above switches can also be integrated in the same module with the control circuit 10.

In one embodiment, the primary switch MP, the first secondary switch MS1, the second secondary switch MS2 and the third secondary switch MS3 include GaN devices. In other embodiments, the above switches can also be other suitable controllable semiconductor devices, such as BJT, JFET, MOSFET, IGBT and so on.

In the example shown in FIG. 1, the control circuit 10 has a plurality of pins, including a first feedback pin FB1, a second feedback pin FB2, a first secondary driving pin SDRV1, a second secondary driving pin SDRV2, a third secondary driving pin SDRV3 and a primary driving pin PDRV.

The first feedback pin FB1 is coupled to the first output terminal OT1 of the multi-output converter 100 to receive a first feedback signal Vfb1 indicative of a first output signal (such as a first output voltage Vo1, a first output current or a first output power of the multi-output converter 100). The second feedback pin FB2 is coupled to the second output terminal OT2 of the multi-output converter 100 to receive a second feedback signal Vfb2 indicative of a second output signal (such as a second output voltage Vo2, a second output current or a second output power of the multi-output converter 100). The first secondary driving pin SDRV1 is configured to provide a first secondary control signal CTRLS1 to the first secondary switch MS1. The second secondary driving pin SDRV2 is configured to provide a second secondary control signal CTRLS2 to the second secondary switch MS2. The third secondary driving pin SDRV3 is configured to provide a third secondary control signal CTRLS3 to the third secondary switch MS3. The primary driving pin PDRV is configured to provide a primary control signal CTRLP to the primary switch MP.

The control circuit 10 generates the primary control signal CTRLP, the first secondary control signal CTRLS1, the second secondary control signal CTRLS2 and the third secondary control signal CTRLS3 to control the corresponding switch respectively based on the first feedback signal Vfb1 and the second feedback signal Vfb2, thereby converting the input voltage Vin into the first output voltage Vo1 and the second output voltage Vo2 to power the first load and the second load respectively.

In one embodiment, in a switching cycle, the control circuit 10 is configured to turn on the first secondary switch MS1 and the second secondary switch MS2 in a time-multiplexed manner, thereby transmitting the power to the first output and the second output in a time-multiplexed manner to achieve power distribution between the first output and the second output. Those skilled in the art can understand that the time-multiplexed manner means that the first secondary switch MS1 and the second secondary switch MS2 are turned on in different time periods during a switching cycle. In some embodiments, the ON time period of the first secondary switch MS1 and the ON time period of the second secondary switch MS2 may be overlapped partly.

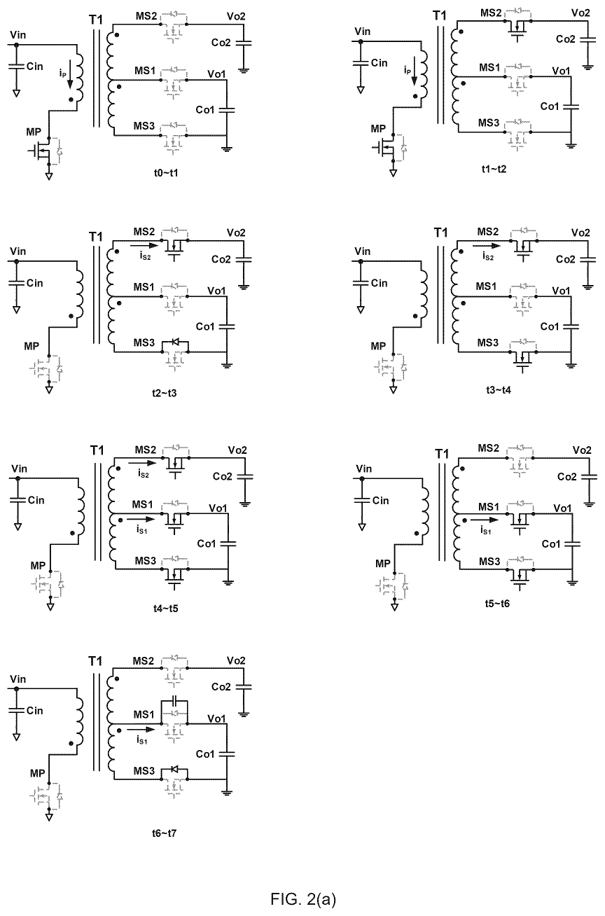

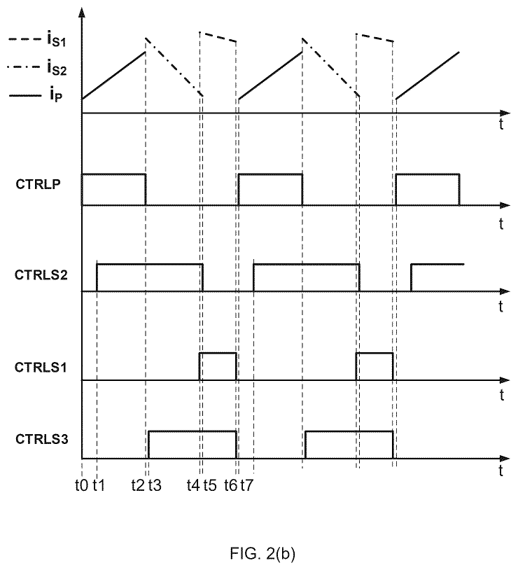

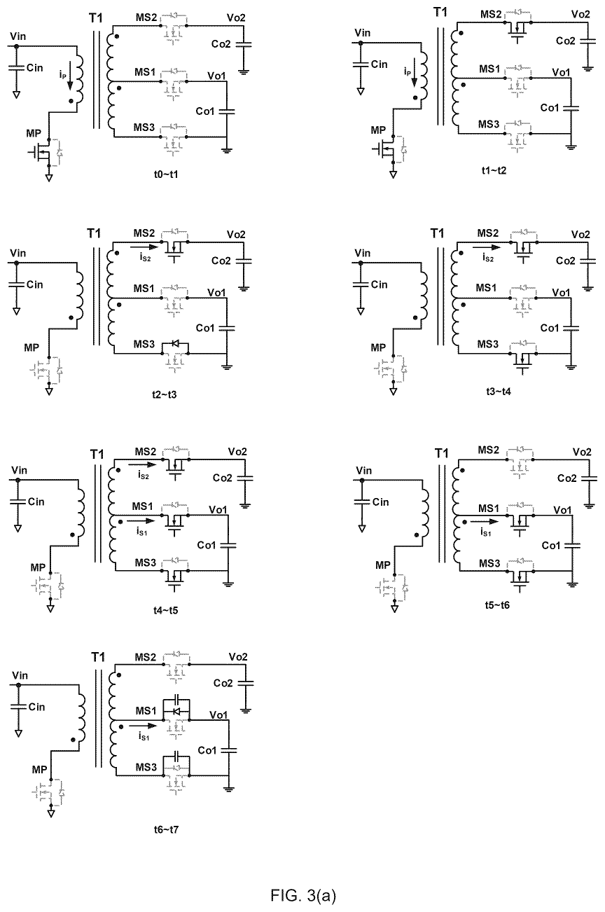

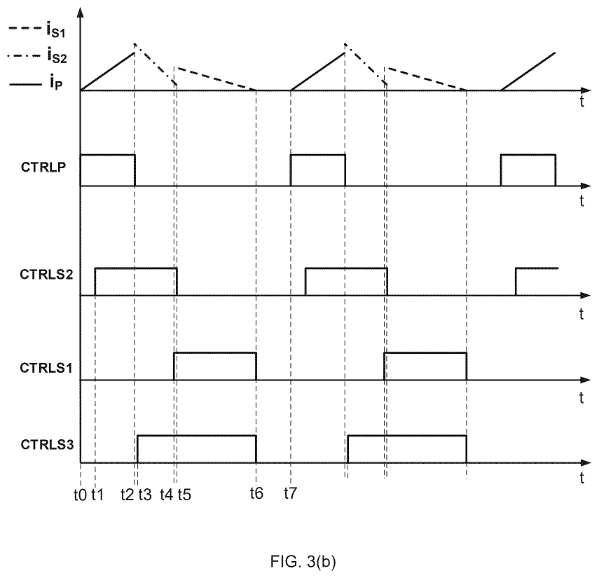

FIG. 2(a) and FIG. 2(b) illustrate working states and working waveforms of the multi-output converter 100 operating in a CCM (continuous conduction mode) in accordance with an embodiment of the present invention. FIG. 3(a) and FIG. 3(b) illustrate working states and working waveforms of the multi-output converter 100 operating in a DCM (discontinuous conduction mode) in accordance with another embodiment of the present invention. The working principle of the multi-output converter 100 will be set forth referring to FIG. 1˜FIG. 3.

FIG. 2(a) illustrates working states of the primary switch MP, the first secondary switch MS1, the second secondary switch MS2 and the third secondary switch MS3 in CCM, where the black solid line indicates that corresponding switch is on, and the gray dashed line indicates that corresponding switch is off. FIG. 2(b) illustrates, from top to bottom, a current is 1 flowing through the first secondary switch MS1, a current is2 flowing through the second secondary switch MS2, a current ip flowing through the primary switch MP, the primary control signal CTRLP, the second secondary control signal CTRLS2, the first secondary control signal CTRLS1 and the third secondary control signal CTRLS3 in CCM. Take a switching cycle t0˜t7 as an example to illustrate.

During time period t0˜t1, the primary switch MP is on, the first secondary switch MS1, the second secondary switch MS2 and the third secondary switch MS3 are all off. The current ip flowing through the primary switch MP increases, and the energy storage element of the multi-output converter 100 (such as the transformer T1) starts to store energy. The first load and the second load are powered by the first output capacitor Co1 and the second output capacitor Co2 respectively.

During time period t1˜t2, the primary switch MP continues to be on, the second secondary switch MS2 is on, the first secondary switch MS1 and the third secondary switch MS3 continue to be off, the current ip flowing through the primary switch MP continues to increase, and the transformer T1 continues to store energy.

During time period t2˜t3, the primary switch MP is off, the second secondary switch MS2 continues to be on, and a body diode of the third secondary switch MS3 conducts. The current is2 flowing through the second secondary switch MS2 decreases, and the energy stored in the transformer T1 starts to be transmitted to the second output to power the second load.

During time period t3˜t4, the primary switch MP continues to be off, the second secondary switch MS2 continues to be on, and the third secondary switch MS3 is on. The energy stored in the transformer T1 continues to be transmitted to the second output to power the second load.

During time period t4˜t5, the primary switch MP continues to be off, the second secondary switch MS2 and the third secondary switch MS3 continues to be on, and the first secondary switch MS1 is also on. Both the current is2 flowing through the second secondary switch MS2 and the current is1 flowing through the first secondary switch MS1 decrease, and the energy stored in the transformer T1 is transmitted to both the first output and the second output to power the first load and the second load respectively.

During time period t5˜t6, the primary switch MP continues to be off, the second secondary switch MS2 is off, and the energy transmission to the second output stops. The first secondary switch MS1 and the third secondary switch MS3 continue to be on, and the energy continues to be transmitted to the first output to power the first load.

During time period t6˜t7, the primary switch MP, the first secondary switch MS1, the second secondary switch MS2, and the third secondary switch MS3 are all off. At this point, the current is1 has not yet decreased to zero, and the body diode of the third secondary switch MS3 conducts. The current is1 charges the parasitic drain-source capacitor of the first secondary switch MS1.

At time t7, the primary switch MP is turned on again, the multi-output converter 100 enters the next switching cycle.

FIG. 3(a) illustrates working states of the primary switch MP, the first secondary switch MS1, the second secondary switch MS2 and the third secondary switch MS3 in DCM, where the black solid line indicates that corresponding switch is on, and the gray dashed line indicates that corresponding switch is off. FIG. 3(b) illustrates, from top to bottom, a current is1 flowing through the first secondary switch MS1, a current is2 flowing through the second secondary switch MS2, a current ip flowing through the primary switch MP, the primary control signal CTRLP, the second secondary control signal CTRLS2, the first secondary control signal CTRLS1 and the third secondary control signal CTRLS3 in DCM. Take a switching cycle t0˜t7 as an example to illustrate.

During time period t0˜t1, the primary switch MP is on, the first secondary switch MS1, the second secondary switch MS2 and the third secondary switch MS3 are all off. The current ip flowing through the primary switch MP increases, and the energy storage element of the multi-output converter 100 (such as the transformer T1) starts to store energy. The first load and the second load are powered by the first output capacitor Co1 and the second output capacitor Co2 respectively.

During time period t1˜12, the primary switch MP continues to be on, the second secondary switch MS2 is on, the first secondary switch MS1 and the third secondary switch MS3 continue to be off, the current ip flowing through the primary switch MP continues to increase, and the transformer T1 continues to store energy.

During time period t2˜t3, the primary switch MP is off, the second secondary switch MS2 continues to be on, and a body diode of the third secondary switch MS3 conducts. The current is2 flowing through the second secondary switch MS2 decreases, and the energy stored in the transformer T1 starts to be transmitted to the second output to power the second load.

During time period t3˜t4, the primary switch MP continues to be off, the second secondary switch MS2 continues to be on, and the third secondary switch MS3 is on. The energy stored in the transformer T1 continues to be transmitted to the second output to power the second load.

During time period t4˜t5, the primary switch MP continues to be off, the second secondary switch MS2 and the third secondary switch MS3 continues to be on, and the first secondary switch MS1 is also on. Both the current is2 flowing through the second secondary switch MS2 and the current is1 flowing through the first secondary switch MS1 decrease, and the energy stored in the transformer T1 is transmitted to both the first output and the second output, to power both the first load and the second load.

During time period t5˜t6, the primary switch MP continues to be off, the second secondary switch MS2 is off, and the energy transmission to the second output stops. The first secondary switch MS1 and the third secondary switch MS3 continue to be on, and the energy continues to be transmitted to the first output to power the first load.

During time period t6˜t7, the primary switch MP, the first secondary switch MS1, the second secondary switch MS2, and the third secondary switch MS3 are all off. At this point, the current is1 decreases to zero substantially, and the transformer T1, the parasitic drain-source capacitor of the first secondary switch MS1 and the parasitic drain-source capacitor of the third secondary switch MS3 start to resonate.

At time t7, the primary switch MP is turned on again, the multi-output converter 100 enters the next switching cycle.

According to the embodiments of the present invention, during a switching cycle, the primary switch MP is turned on first, allowing the energy to be stored in the transformer T1. Afterwards, the second secondary switch MS2 and the first secondary switch MS1 are turned on in a time-multiplexed manner, and the energy stored in the transformer T1 is transmitted to the second output and the first output respectively, thereby achieving the energy distribution between the first output and the second output.

In the example shown in FIG. 2 and FIG. 3, the turning on of the second secondary switch MS2 is earlier than the turning off of the primary switch MP (i.e., the second secondary switch MS2 is turned on before the primary switch MP is turned off), and the turning on of the first secondary switch MS1 is earlier than the turning off of the second secondary switch MS2 (i.e., the first secondary switch MS1 is turned on before the second secondary switch MS2 is turned off), thereby avoiding no freewheeling path for the current flowing through the transformer T1.

Although the second secondary switch MS2 is turned on first and the first secondary switch MS1 is turned on later in the embodiments shown in FIG. 2 and FIG. 3, so that energy is first transmitted to the second output and then transmitted to the first output. However, those skilled in the art can understand that in other embodiments, the first secondary switch MS1 can be turned on first and the second secondary switch MS2 can be turned on later, so that energy is first transmitted to the first output and then transmitted to the second output.

In one embodiment, in a switching cycle, the turning on order of the first secondary switch and the second secondary switch is determined based on the power demand of the first load and the power demand of the second load. In a further embodiment, in response to the power demand of the first load being higher than the power demand of the second load, after the primary switch is turned on, the control circuit 10 is configured to turn on the first secondary switch MS1 first and turn on the second secondary switch MS2 later. In response to the power demand of the second load being higher than the power demand of the first load, after the primary switch is turned on, the control circuit 10 is configured to turn on the second secondary switch MS2 first and turn on the first secondary switch MS1 later.

In one embodiment, the first feedback signal Vfb1 and the second feedback signal Vfb2 can reflect the power demand of the first load and the power demand of the second load respectively, the control circuit 10 can determine which one of the power demand of the first load and the power demand of the second load is higher based on the first feedback signal Vfb1 and the second feedback signal Vfb2, and then turn on the corresponding switch coupled to the load having higher power demand first. In another embodiment, the control circuit 10 can receive a signal indicates which one of the power demand of the first load and the power demand of the second load is higher. In yet another embodiment, the control circuit 10 can turn on the first secondary switch MS1 first by default and the load having higher power demand is coupled to the first output by default.

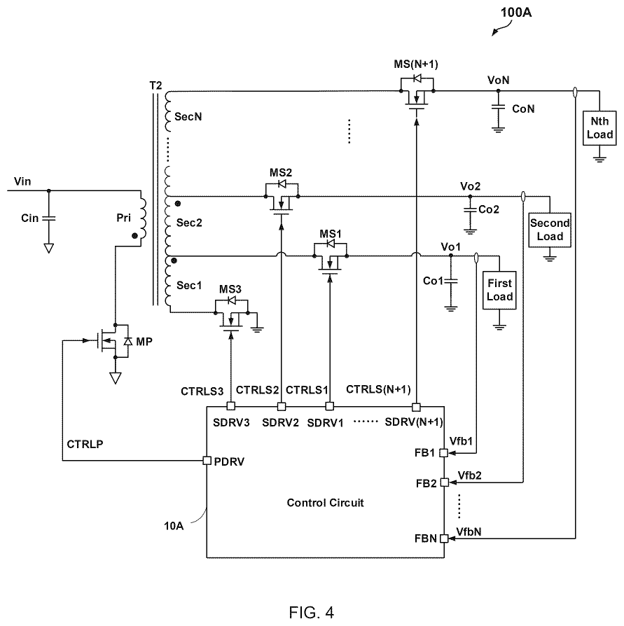

Although the multi-output converter 100 shown in FIG. 1˜FIG. 3 has two outputs, those skilled in the art can understand that the two-output converter is used for illustrative purpose, the multi-output converter can include more outputs. FIG. 4 illustrates a block diagram of a multi-output converter 100A in accordance with another embodiment of the present invention. As shown in FIG. 4, the multi-output converter 100A includes an input capacitor Cin, a transformer T2, a primary switch MP, a first secondary switch MS1˜a (N+1)th secondary switch MS (N+1), a first output capacitor Co1˜a Nth output capacitor CON and a control circuit 10A, connected as shown in FIG. 4.

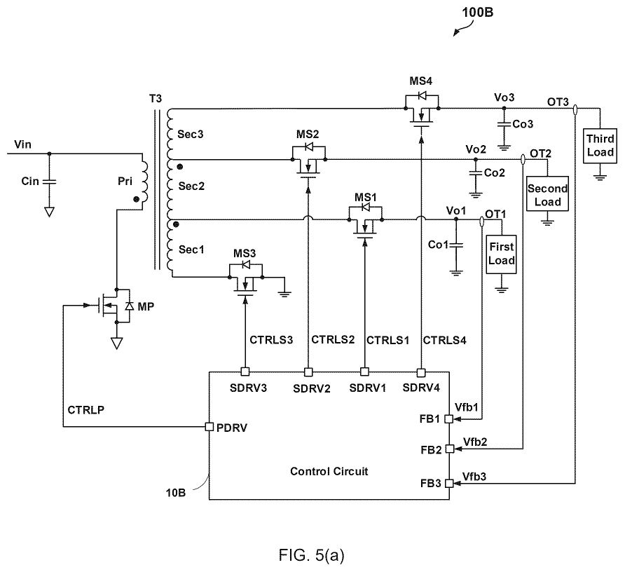

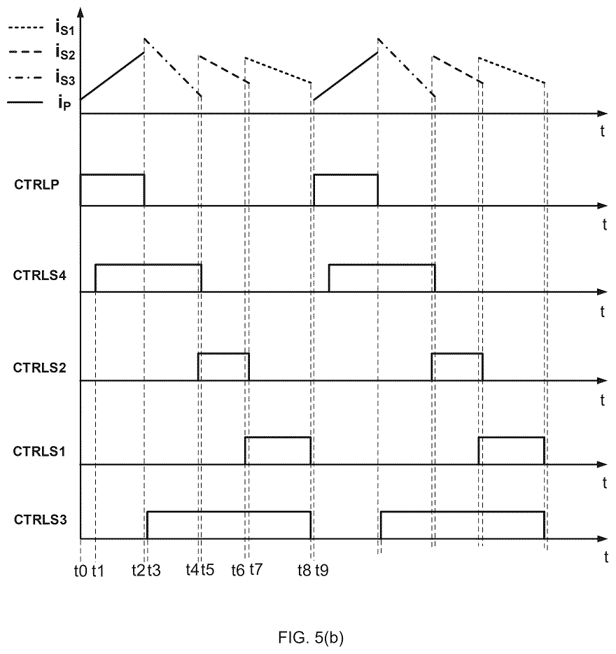

The control circuit 10A generates a plurality of switch control signals to control the primary switch MP and the first secondary switch MS1˜the (N+1)th secondary switch MS (N+1) based on a first feedback signal Vfb1˜a Nth feedback signal VfbN, thereby converting an input voltage Vin into a first output voltage Vo1˜a Nth output voltage VON to power a first load˜a Nth load respectively. Take three loads as an example, the working principle will be set forth referring to FIG. 5.

FIG. 5(a) and FIG. 5(b) illustrate a block diagram and working waveforms of a multi-output converter 100B in accordance with an embodiment of the present invention. As shown in FIG. 5(a), the multi-output converter 100B includes an input capacitor Cin, a transformer T3, a primary switch MP, a first secondary switch MS1, a second secondary switch MS2, a third secondary switch MS3, a fourth secondary switch MS4, a first output capacitor Co1, a second output capacitor Co2, a third output capacitor Co3 and a control circuit 10B.

The transformer T3 has a primary winding Pri, a first secondary winding Sec1, a second secondary winding Sec2 and a third secondary winding Sec3, where the primary winding Pri, the first secondary winding Sec1, the second secondary winding Sec2 and the third secondary winding Sec3 all have a first terminal and a second terminal. The first terminal of the primary winding Pri is configured to receive an input voltage Vin. The primary switch MP is coupled between the second terminal of the primary winding Pri and a primary reference ground.

As shown in FIG. 5(a), the first secondary switch MS1 is coupled between the first output capacitor Co1 and the first terminal of the first secondary winding Sec1. A first load is coupled to a first output terminal OT1 of the multi-output converter 100B. When the first secondary switch MS1 is on, the multi-output converter 100B is configured to power the first load. The second secondary switch MS2 is coupled between the second output capacitor Co2 and the first terminal of the second secondary winding Sec2. A second load is coupled to a second output terminal OT2 of the multi-output converter 100B. When the second secondary switch MS2 is on, the multi-output converter 100B is configured to power the second load. The second terminal of the second secondary winding Sec2 is coupled to the first terminal of the first secondary winding Sec1. The fourth secondary switch MS4 is coupled between the third output capacitor Co3 and the first terminal of the third secondary winding Sec3. A third load is coupled to a third output OT3 of the multi-output converter 100B. When the third secondary switch MS3 is on, the multi-output converter 100B is configured to power the third load. The second terminal of the third secondary winding Sec3 is coupled to the first terminal of the second secondary winding Sec2. The third secondary switch MS3 is coupled between the second terminal of the first secondary winding Sec1 and a secondary reference ground.

In the example shown in FIG. 5(a), the control circuit 10B controls the primary switch MP and the first secondary switch MS1˜the fourth secondary switch MS4 based on a first feedback signal Vfb1 indicative of a first output signal˜a third feedback signal Vfb3 indicative of a third output signal, thereby converting the input voltage Vin into a first output voltage Vo1˜a third output voltage Vo3 to power a first load˜a third load respectively.

FIG. 5(b) illustrates, from top to bottom, a current is1 flowing through the first secondary switch MS1, a current is2 flowing through the second secondary switch MS2, a current is3 flowing through the fourth secondary switch MS4, a current ip flowing through the primary switch MP, the primary control signal CTRLP, the fourth secondary control signal CTRLS4, the second secondary control signal CTRLS2, the first secondary control signal CTRLS1 and the third secondary control signal CTRLS3 in DCM. Take a switching cycle t0˜t9 as an example to illustrate.

During time period t0˜t1, the primary switch MP is on, the first secondary switch MS1, the second secondary switch MS2, the third secondary switch MS3 and the fourth secondary switch MS4 are all off. The current ip flowing through the primary switch MP increases, and the energy storage element of the multi-output converter 100B (such as the transformer T3) starts to store energy. The first load, the second load and the third load are powered by the first output capacitor Co1, the second output capacitor Co2 and the third output capacitor Co3 respectively.

During time period t1˜2, the primary switch MP continues to be on, the fourth secondary switch MS4 is on, the first secondary switch MS1, the second secondary switch MS2 and the third secondary switch MS3 continue to be off, the current ip flowing through the primary switch MP continues to increase, and the transformer T3 continues to store energy.

During time period t2˜t3, the primary switch MP is off, the fourth secondary switch MS4 continues to be on, and a body diode of the third secondary switch MS3 conducts. The current is3 flowing through the fourth secondary switch MS4 decreases, and the energy stored in the transformer T3 starts to be transmitted to the third output, to power the third load.

During time period t3˜t4, the primary switch MP continues to be off, the fourth secondary switch MS4 continues to be on, and the third secondary switch MS3 is on. The energy stored in the transformer T3 continues to be transmitted to the third output to power the third load.

During time period t4˜t5, the primary switch MP continues to be off, the fourth secondary switch MS4 and the third secondary switch MS3 continues to be on, and the second secondary switch MS2 is also on. Both the current is3 flowing through the fourth secondary switch MS4 and the current is2 flowing through the second secondary switch MS2 decrease, and the energy stored in the transformer T3 is transmitted to both the third output and the second output, to power both the third load and the second load respectively.

During time period t5˜t6, the primary switch MP continues to be off, the fourth secondary switch MS4 is off, and the energy transmission to the third output stops. The second secondary switch MS2 and the third secondary switch MS3 continue to be on, and the energy continues to be transmitted to the second output to power the second load.

During time period t6˜t7, the primary switch MP continues to be off, the second secondary switch MS2 and the third secondary switch MS3 continues to be on, and the first secondary switch MS1 is also on. Both the current is2 flowing through the second secondary switch MS2 and the current is1 flowing through the first secondary switch MS1 decrease, and the energy stored in the transformer T3 is transmitted to both the first output and the second output, to power both the first load and the second load.

During time period t7˜t8, the primary switch MP continues to be off, the second secondary switch MS2 is off, and the energy transmission to the second output stops. The first secondary switch MS1 and the third secondary switch MS3 continue to be on, and the energy continues to be transmitted to the first output to power the first load.

During time period t8˜19, the primary switch MP, the first secondary switch MS1, the second secondary switch MS2, the third secondary switch MS3 and the fourth secondary switch MS4 are all off. The energy transmission to the first output stops.

At time t9, the primary switch MP is turned on again, the multi-output converter 100B enters the next switching cycle.

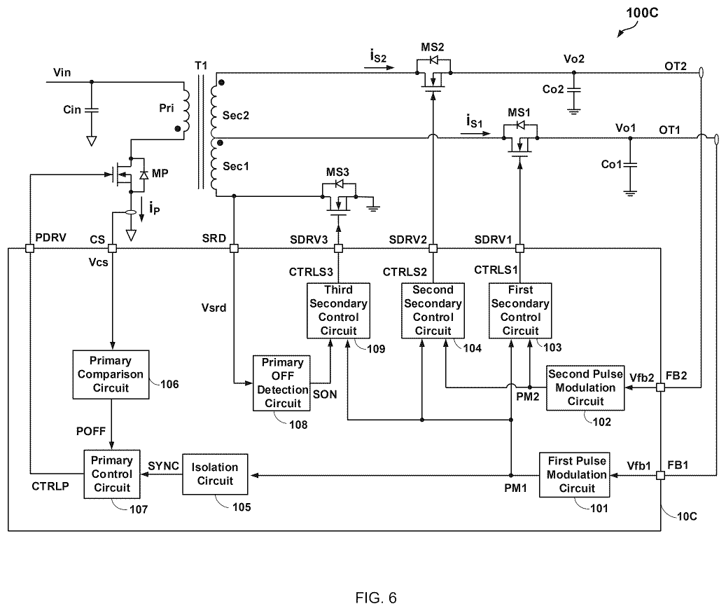

FIG. 6 illustrates a circuit schematic of a multi-output converter 1000 in accordance with an embodiment of the present invention. The multi-output converter 100C includes an input capacitor Cin, a transformer T1, a primary switch MP, a first secondary switch MS1, a second secondary switch MS2, a third secondary switch MS3, a first output capacitor Co1, a second output capacitor Co2 and a control circuit 10C.

The control circuit 10C has a plurality of pins, including a first feedback pin FB1, a second feedback pin FB2, a first secondary driving pin SDRV1, a second secondary driving pin SDRV2, a third secondary driving pin SDRV3, a drain voltage detecting pin SRD, a current sensing pin CS and a primary driving pin PDRV.

The first feedback pin FB1 is coupled to a first output terminal OT1 of the multi-output converter 100C to receive a first feedback signal Vfb1 indicative of a first output signal of the multi-output converter 100C. The second feedback pin FB2 is coupled to a second output terminal OT2 of the multi-output converter 100C to receive a second feedback signal Vfb2 indicative of a second output signal of the multi-output converter 100C. The first secondary driving pin SDRV1 is coupled to a control terminal of the first secondary switch MS1 to provide the first secondary control signal CTRLS1. The second secondary driving pin SDRV2 is coupled to a control terminal of the second secondary switch MS2 to provide the second secondary control signal CTRLS2. The third secondary driving pin SDRV3 is coupled to a control terminal of the third secondary switch MS3 to provide the third secondary control signal CTRLS3. The drain voltage detecting pin SRD is coupled to a drain terminal of the third secondary switch MS3 to receive a drain voltage Vsrd of the third secondary switch MS3. The current sensing pin CS is coupled to the primary switch MP to receive a primary current sensing signal Vos indicative of a current ip flowing through the primary switch MP. The primary driving pin PDRV is coupled to a control terminal of the primary switch MP to provide the primary control signal CTRLP.

In the example shown in FIG. 6, the control circuit 10C further includes a first pulse modulation circuit 101, a second pulse modulation circuit 102, a first secondary control circuit 103, a second secondary control circuit 104, an isolation circuit 105, a primary comparison circuit 106, a primary control circuit 107, a primary OFF detection circuit 108 and a third secondary control circuit 109.

The first pulse modulation circuit 101 is coupled to the first feedback pin FB1 to receive the first feedback signal Vfb1 and generates a first pulse modulation signal PM1 based on the first feedback signal Vfb1. In one embodiment, the first pulse modulation circuit 101 compares a first modulation signal with an error amplifying signal between a first reference signal and the first feedback signal Vfb1 to generate the first pulse modulation signal PM1.

The second pulse modulation circuit 102 is coupled to the second feedback pin FB2 to receive the second feedback signal Vfb2 and generates a second pulse modulation signal PM2 based on the second feedback signal Vfb2. In one embodiment, the second pulse modulation circuit 102 compares a second modulation signal with an error amplifying signal between a second reference signal and the second feedback signal Vfb2 to generate the second pulse modulation signal PM2.

The first secondary control circuit 103 receives the first pulse modulation signal PM1 and the second pulse modulation signal PM2 and generates the first secondary control signal CTRLS1 to control the first secondary switch MS1. In one embodiment, the first secondary control circuit 103 controls the turning on of the first secondary switch MS1 based on the second pulse modulation signal PM2 and controls the turning off of the first secondary switch MS1 based on the first pulse modulation signal PM1.

The second secondary control circuit 104 receives the first pulse modulation signal PM1 and the second pulse modulation signal PM2 and generates the second secondary control signal CTRLS2 to control the second secondary switch MS2. In one embodiment, the second secondary control circuit 104 controls the turning on of the second secondary switch MS2 based on the first pulse modulation signal PM1 and controls the turning off of the second secondary switch MS2 based on the second pulse modulation signal PM2.

The isolation circuit 105 receives the first pulse modulation signal PM1 and generates a synchronous signal SYNC electrically isolated from the first pulse modulation signal PM1. In one embodiment, the isolation circuit 105 includes opto-couplers, transformers, capacitive isolation devices or other suitable isolation devices. In other embodiments, the isolation circuit 105 may receive the second pulse modulation signal PM2 and generate the synchronous signal SYNC electrically isolated from the second pulse modulation signal PM2.

The primary comparison circuit 106 detects whether the current ip flowing through the primary switch MP exceeds a current threshold and generates a primary comparison signal POFF. In the example shown in FIG. 6, the primary comparison circuit 106 is coupled to the current sensing pin CS to receive the primary current sensing signal Vos indicative of the current ip, and compares the primary current sensing signal Vos with a first voltage threshold to generate the primary comparison signal POFF.

The primary control circuit 107 receives the synchronous signal SYNC and the primary comparison signal POFF and generates the primary control signal CTRLP to control the primary switch MP based on the synchronous signal SYNC and the primary comparison signal POFF. In one embodiment, the primary control circuit 107 controls the turning on of the primary switch MP based on the synchronous signal SYNC and controls the turning off of the primary switch MP based on the primary comparison signal POFF.

The primary OFF detection circuit 108 detects whether the primary switch MP has been turned off and generates a primary OFF detection signal SON. In the example shown in FIG. 6, the primary OFF detection circuit 108 is coupled to the drain voltage detecting pin SRD to receive the drain voltage Vsrd of the third secondary switch MS3 and compares the drain voltage Vsrd with a second voltage threshold to generate the primary OFF detection signal SON. In other embodiments, the primary OFF detection circuit 108 may determine whether the primary switch MP has been turned off based on other electrical parameters such as the current flowing through the third secondary switch MS3 or may obtain a signal indicating whether the primary switch MP has been turned off from the primary side.

The third secondary control circuit 109 receives the first pulse modulation signal PM1 and the primary OFF detection signal SON and generates the third secondary control signal CTRLS3 to control the third secondary switch MS3. In one embodiment, the third secondary control circuit 109 controls the turning on of the third secondary switch MS3 based on the primary OFF detection signal SON and controls the turning off of the third secondary switch MS3 based on the first pulse modulation signal PM1. In other embodiments, the third secondary control circuit 109 may receive the second pulse modulation signal PM2 and control the turning off of the third secondary switch MS3 based on the second pulse modulation signal PM2.

Those skilled in the art can understand that, the control circuit 10C shown in FIG. 6 is used for illustrative purposes, not for limiting the present invention. In the embodiments of the present invention, the control circuit can adopt many control methods, such as PWM control, Quasi-resonant control, off-time control and so on.

According to the embodiments of the present invention, the control circuit 10C generates the first secondary control signal CTRLS1 and the second secondary control signal CTRL2 to control the first secondary switch MS1 and the second secondary switch MS2 respectively based on the first feedback signal Vfb1 and the second feedback signal Vfb2. The control circuit 10C introduces the information of both the first output voltage Vo1 and the second output voltage Vo2 to the control loop. The first secondary switch MS1 and the second secondary switch MS2 are controlled to be turned on in a time-multiplexed manner during a switching cycle. The energy is transmitted to the first output and the second output in a time-multiplexed manner and accurate regulation of the first output and the second output are realized.

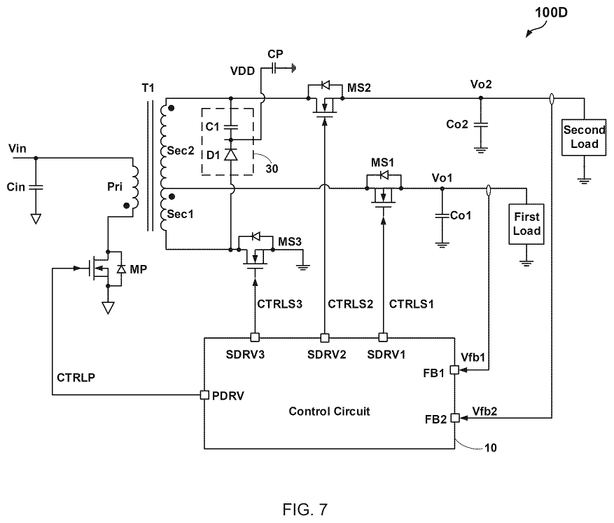

FIG. 7 illustrates a circuit schematic of a multi-output converter 100D in accordance with another embodiment of the present invention. Different from the multi-output converter 100 shown in FIG. 1, the multi-output converter 100D further includes a startup supply circuit 30 and a supply capacitor CP. The supply capacitor CP is coupled between the startup supply circuit 30 and a secondary reference ground. The startup supply circuit 30 is used to power a control circuit on the secondary side of the multi-output converter 100D when the output voltage has not yet been established after the converter just starts, where the voltage across the supply capacitor CP is a supply voltage VDD.

In the example shown in FIG. 7, the startup supply circuit 30 includes a unidirectional device D1 and a first capacitor C1. An input terminal of the unidirectional device D1 is coupled to the second terminal of the first secondary winding Sec1. An output terminal of the unidirectional device D1 is coupled to a first terminal of the first capacitor C1. A second terminal of the first capacitor C1 is coupled to a first terminal of the second secondary winding Sec2. In one embodiment, the unidirectional device D1 includes a diode. When the primary switch MP is on, the transformer T1 charges the first capacitor C1 through the unidirectional device D1. When the primary switch MP is off, a path through the first capacitor C1, the supply capacitor CP, a body diode of the third secondary switch MS3, the first secondary winding Sec1 and the second secondary winding Sec2, is provided to charge the supply capacitor CP.

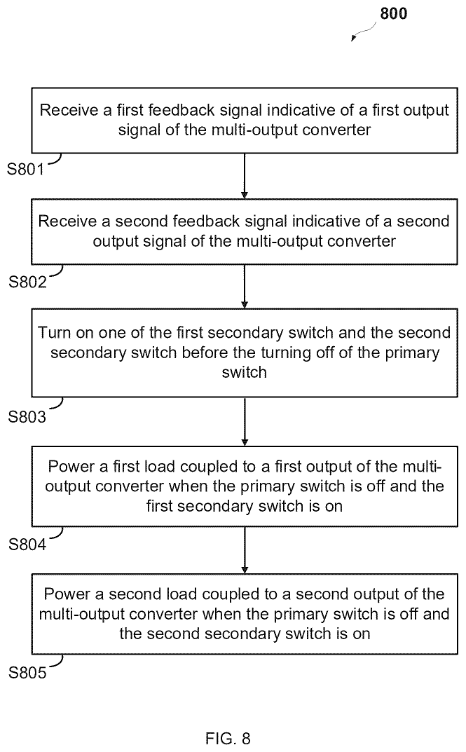

FIG. 8 illustrates a working flowchart of a control method 800 used in a multi-output converter in accordance with an embodiment of the present invention. The multi-output converter includes a transformer having a primary winding, a first secondary winding and a second secondary winding, a primary switch coupled to the primary winding, a first secondary switch coupled to the first secondary winding and a second secondary switch coupled to the second secondary winding. The control method 800 includes steps S801˜S805.

At step S801, a first feedback signal indicative of a first output signal of the multi-output converter is received.

At step S802, a second feedback signal indicative of a second output signal of the multi-output converter is received.

At step S803, one of the first secondary switch and the second secondary switch is turned on before the turning off of the primary switch.

At step S804, a first load coupled to a first output of the multi-output converter is powered when the primary switch is off, and the first secondary switch is on.

At step S805, a second load coupled to a second output of the multi-output converter is powered when the primary switch is off, and the second secondary switch is on.

In one embodiment, the control method 800 further includes: the first load and the second load are both powered when the primary switch is off, and both the first secondary switch and the second secondary switch are on.

In one embodiment, the control method 800 further includes: the first secondary switch and the second secondary switch are both turned off before the turning on of the primary switch.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a multi-output converter, comprising:
a first feedback pin configured to be coupled to a first output terminal of the multi-output converter and configured to receive a first feedback signal indicative of a first output signal; and
a second feedback pin configured to be coupled to a second output terminal of the multi-output converter and configured to receive a second feedback signal indicative of a second output signal; wherein
the control circuit is configured to control a first secondary switch coupled to the first output terminal and a second secondary switch coupled to the second output terminal based on the first feedback signal and the second feedback signal; and wherein
during a first switching cycle of multiple switching cycles, the control circuit is configured to turn on the first secondary switch and the second secondary switch in a time-multiplexed manner.

2. The control circuit of claim 1, wherein during a first time period of the first switching cycle, the control circuit is configured to turn on both a primary switch and the first secondary switch.

3. The control circuit of claim 1, wherein during a second time period of the first switching cycle, the control circuit is configured to turn on both the first secondary switch and the second secondary switch.

4. The control circuit of claim 1, wherein:
when a primary switch is off and the first secondary switch is on, the multi-output converter is configured to provide power to the first output terminal; and wherein
when the primary switch is off and the second secondary switch is on, the multi-output converter is configured to provide power to the second output terminal; and wherein
when the primary switch is off and both the first secondary switch and the second secondary switch are on, the multi-output converter is configured to provide power to both the first output terminal and the second output terminal.

5. The control circuit of claim 1, wherein during the first switching cycle, the control circuit is configured to determine a turning on order of the first secondary switch and the second secondary switch based on a power demand of a first load coupled to the first output terminal and a power demand of a second load coupled to the second output terminal.

6. The control circuit of claim 5, wherein:
the control circuit is configured to turn on the first secondary switch first and to turn on the second secondary switch later in response to the power demand of the first load being higher than the power demand of the second load; and wherein
the control circuit is configured to turn on the second secondary switch first and to turn on the first secondary switch later in response to the power demand of the second load being higher than the power demand of the first load.

7. The control circuit of claim 1, wherein at least one of the first secondary switch and the second secondary switch comprises GaN device.

8. The control circuit of claim 1, wherein:
the control circuit is configured to turn on a third secondary switch after turning off a primary switch and to turn off the third secondary switch before turning on the primary switch.

9. The control circuit of claim 1, further comprising:
a first pulse modulation circuit coupled to the first feedback pin and configured to generate a first pulse modulation signal based on the first feedback signal;
a second pulse modulation circuit coupled to the second feedback pin and configured to generate a second pulse modulation signal based on the second feedback signal;
a first secondary control circuit configured to generate a first secondary control signal to control the first secondary switch based on the first pulse modulation signal and the second modulation signal;
a second secondary control circuit configured to generate a second secondary control signal to control the second secondary switch based on the second pulse modulation signal and the first pulse modulation signal;
an isolation circuit configured to generate a synchronous signal electrically isolated from the first pulse modulation signal or the second pulse modulation signal; and
a primary control circuit configured to generate a primary control signal to control a primary switch based on the synchronous signal.

10. A multi-output converter, comprising:
a transformer having a primary winding, a first secondary winding and a second secondary winding;
a primary switch coupled to the primary winding;
a first secondary switch coupled between the first secondary winding and a first output terminal;
a second secondary switch coupled between the second secondary winding and a second output terminal; and
a control circuit configured to receive a first feedback signal indicative of a first output signal provided through the first output terminal and a second feedback signal indicative of a second output signal provided through the second output terminal, and configured to control the primary switch, the first secondary switch and the second secondary switch based on the first feedback signal and the second feedback signal; wherein
during a first time period of a first switching cycle of multiple switching cycles, the control circuit is configured to turn on both the first secondary switch and the primary switch.

11. The multi-output converter of claim 10, wherein:
during the first switching cycle, the control circuit is configured to turn on the first secondary switch and the second secondary switch in a time-multiplexed manner.

12. The multi-output converter of claim 10, wherein during the first switching cycle, the control circuit is configured to determine a turning on order of the first secondary switch and the second secondary switch based on a power demand of a first load coupled to the first output terminal and a power demand of a second load coupled to the second output terminal.

13. The multi-output converter of claim 10, wherein at least one of the primary switch, the first secondary switch and the second secondary switch comprises GaN device.

14. The multi-output converter of claim 10, further comprising:
a third secondary switch coupled to a third secondary winding of the transformer; wherein
in a first time period of a second switching cycle of multiple switching cycles, the control circuit is configured to turn on both the primary switch and the third secondary switch.

15. The multi-output converter of claim 10, further comprising:
a startup supply circuit, comprising:
a unidirectional device having an input terminal and an output terminal, wherein the input terminal is coupled to the first secondary winding; and
a first capacitor having a first terminal and a second terminal, wherein the first terminal is coupled to the output terminal of the unidirectional device, and the second terminal is coupled to the second secondary winding; and
a supply capacitor coupled between a secondary reference ground and a common connection node between the unidirectional device and the first capacitor.

16. The multi-output converter of claim 10, further comprising:
a diode coupled between the first secondary winding and a secondary reference ground.

17. A control method for a multi-output converter, comprising:
receiving a first feedback signal indicative of a first output signal provided through a first output terminal;
receiving a second feedback signal indicative of a second output signal provided through a second output terminal;
controlling a primary switch, a first secondary switch and a second secondary switch based on the first feedback signal and the second feedback signal; and
during a first time period of a first switching cycle of multiple switching cycles, turning on both the primary switch and the first secondary switch.

18. The control method of claim 17, further comprising:
during the first switching cycle, turning on the first secondary switch and the second secondary switch in a time-multiplexed manner.

19. The control method of claim 17, further comprising:
during a second period of the first switching cycle, turning off both the first secondary switch and the second secondary switch; and
during a third time period of a second switching cycle after the first switching cycle, turning on the primary switch.

20. The control method of claim 17, wherein during the first switching cycle, a turning on order of the first secondary switch and the second secondary switch is determined based on a power demand of a first load coupled to the first output terminal and a power demand of a second load coupled to the second output terminal.
